(19) United States
(12) Patent Application Publication
(10) Pub. No.: US 2021/0092091 A1
(43) Pub. Date: Mar. 25, 2021

(54) COMMUNICATION DEVICE FOR VEHICLE, COMMUNICATION SYSTEM FOR VEHICLE, AND COMMUNICATION METHOD

(71) Applicant: TOYOTA JIDOSHA KABUSHIKI KAISHA, Toyota-shi (JP)

(72) Inventor: Akiyoshi YAMADA, Okazaki-shi (JP)

(73) Assignee: TOYOTA JIDOSHA KABUSHIKI KAISHA, Toyota-shi (JP)

(21) Appl. No.: 16/940,797

(22) Filed: Jul. 28, 2020

(30) Foreign Application Priority Data
Sep. 20, 2019 (JP) 2019-171419

(51) Int. Cl. H04L 29/12; H04L 29/08

(52) U.S. Cl. CPC H04L 61/2038; H04L 67/12

(57) ABSTRACT

A communication device for a vehicle includes: a memory; and a processor coupled to the memory, the processor being configured to: set one address, from a storage section in which a plurality of addresses are stored, as an address for communication for a time at which a first control device, which carries out control of a vehicle, communicates with a second control device, transmit data from the first control device to the second control device via the address for communication, and in a case in which the transmitted data cannot be received at the second control device, newly set another address from the storage section as the address for communication.

### CROSS-REFERENCE TO RELATED APPLICATION

This application is based on and claims priority under 35 USC 119 from Japanese Patent Application No. 2019-171419, filed on Sep. 20, 2019, the disclosure of which is incorporated by reference herein.

### BACKGROUND

### Technical Field

The present disclosure relates to a communication device for a vehicle, a communication system for a vehicle, and a communication method.

### Related Art

Japanese Patent Application Laid-Open (JP-A) No. 2007-92640 discloses an onboard communication system in which, a master control section and respective slave control sections are connected by wire harnesses, and IDs are assigned automatically to the respective slave control sections by using the property that the resistance values differ in accordance with the wire lengths of the respective wire harnesses.

However, in the technique of JP-A No. 2007-92640, if wire harnesses having the same resistance values are used within a vehicle (network), an ID will be duplicated at slave control sections, and communication becomes impossible. Thus, a method using a computer network such as Ethernet or the like in communication at a communication device for a vehicle has also been contemplated. However, because unique addresses are not set at devices having the same part number, if a plurality of such devices are installed in a vehicle, the address will be duplicated by the address assigning rule. Namely, there is room for improvement in carrying out communication within a vehicle correctly.

### SUMMARY

The present disclosure provides a communication device for a vehicle, a communication system for a vehicle, and a communication method that may enable communication within a vehicle to be carried out correctly, even in a case in which devices having the same part number are installed on an in-vehicle network.

A first aspect of the present disclosure is a communication device including: an address set section that sets one address from a storage section in which plural addresses are stored, as an address for communication for a time at which a first control device, which carries out control of a vehicle, communicates with another second control device; a transmit section that transmits data from the first control device to the second control device via the address for communication; and an address reset section that, in a case in which the transmitted data by the transmit section cannot be received at the second control device, newly set another address from the storage section as the address for communication.

The communication device for a vehicle of the first aspect, plural addresses are stored in the storage section. The address set section sets one address from the storage section as the address for communication for the time when the first control device communicates with the second control device. Further, the transmit section transmits data from the first control device to the second control device via the address for communication. Here, in a case in which the transmitted data cannot be received at the second control device, another address is newly set by the address reset section as the address for communication. Due thereto, even in a case in which devices having the same part number are installed on an in-vehicle network and addresses are duplicated, communication within the vehicle may be carried out correctly due to the another address being newly set.

In a second aspect of the present disclosure, in the first aspect, the communication device for a vehicle may further include a parameter set section that, in a case in which the data that was transmitted by the transmit section is received at the second control device, sets, on the basis of the address for communication, a parameter for an instrument that the first control device controls.

The communication device for a vehicle of the second aspect, because the instrument that the first control device controls is specified on the basis of the address for communication, the correct parameter of that instrument may be set by the parameter set section. Due thereto, the instrument may be controlled correctly by the first control device.

In a third aspect of the present disclosure, in the second aspect, the instrument may be a sensor that detects peripheral information of the vehicle.

The communication device for a vehicle of the third aspect, a parameter, such as the detection viewing angle of a sensor, or the like may be set correctly.

A fourth aspect of the present disclosure is communication system for a vehicle including: the communication device for a vehicle of any of the first aspect through the third aspect; and the second control device, wherein plural ports, which are for receiving data transmitted from an exterior, and filters, which are set per port and refuse receipt of data transmitted from other than a specific address, are provided at the second control device.

The communication system for a vehicle of the fourth aspect, by setting a filter per port, it may be possible to easily receive only data from a specific address. Due thereto, the correct address for communication for the time of communication with the second control device may be set by a simple structure.

A fifth aspect of the present disclosure is communication method including: address setting step of setting one address from a storage section in which plural addresses are stored, as an address for communication for a time at which a first control device, which carries out control of a vehicle, communicates with second control device; a transmitting step of transmitting data from the first control device to the second control device via the address for communication; and an address resetting step of, in a case in which the transmitted data cannot be received at the second control device, newly setting another address from the storage section as the address for communication.

The communication method of the fifth aspect, in the address setting step, one address in the storage section is set as the address for communication for the time when the first control device communicates with the second control device. Further, in the transmitting step, data is transmitted from the first control device to the second control device by the address for communication. Moreover, in the address resetting step, in a case in which the data that was transmitted by the transmit section cannot be received at the second control device, another address is newly set as the address for communication. Due thereto, even in a case in which devices having the same part number are installed on an in-vehicle network and addresses are duplicated, communication within the vehicle may be carried out correctly due to the another address being newly set.

In accordance with the present disclosure, communication within a vehicle may be carried out correctly even in a case in which devices having the same part number are installed on an in-vehicle network.

### BRIEF DESCRIPTION OF THE DRAWINGS

Exemplary embodiment of the present disclosure will be described in detail based on the following figures, wherein:

FIG. 1 is a block drawing illustrating hardware configuration of a communication system for a vehicle;

FIG. 2 is a block drawing illustrating an example of functional configuration of a communication device for a vehicle; and

FIG. 3 is a flowchart illustrating an example of the flow of communication starting processing.

### DETAILED DESCRIPTION

A communication system 50 for a vehicle, which includes a communication device 12 for a vehicle relating to an embodiment, is described with reference to the drawings.

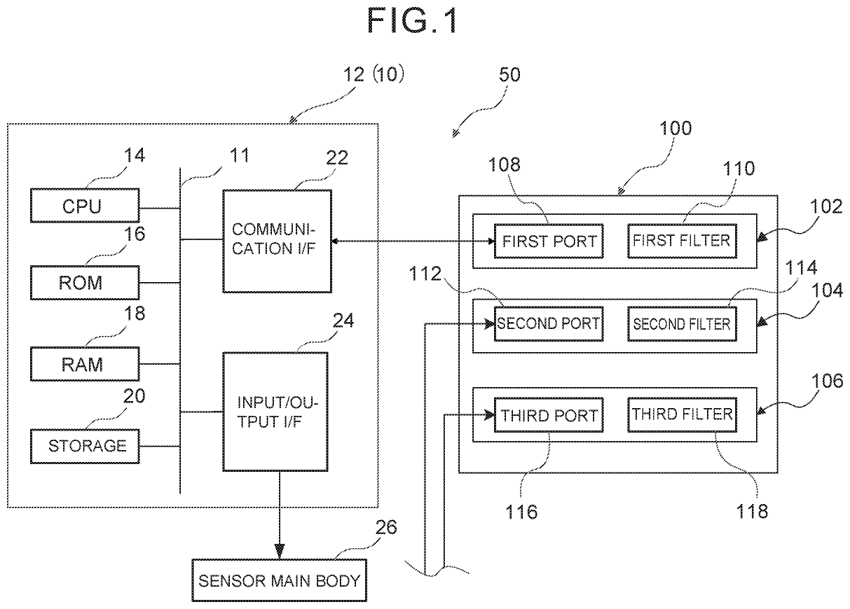

As illustrated in FIG. 1, the communication system 12 for a vehicle of the present embodiment is configured to include an ECU (Electronic Control Unit) 10 that serves as the first control device, and another ECU 100 that serves as the second control device. Further, the communication device 12 for a vehicle of the present embodiment is a portion of the ECU 10. The ECU 10 is electrically connected to the another ECU 100 via a communication interface 22 that is described later, and an environment in which communication is possible is established.

(Structure of ECU 10)

The ECU 10 is configured to include a CPU (Central Processing Unit: a processor) 14, a ROM (Read Only Memory) 16 that serves as a storage section, a RAM (Random Access Memory) 18, a storage 20, the communication interface 22 and an input/output interface 24. These respective configuration are connected via a bus 11 so as to be able to communicate with one another. The CPU 14 is an example of the processor, and the RAM 18 is an example of the memory.

The CPU 14 is a central computing processing unit, and executes various programs and controls various sections. Namely, the CPU 14 reads-out programs from the ROM 16 or the storage 20, and executes the programs by using the RAM 18 as a workspace. The CPU 14 carries out control of the above-described respective configuration and various computing processings in accordance with programs recorded in the ROM 16 or the storage 20.

The ROM 16 stores various programs and various data. The RAM 18 temporarily stores programs and data as a workspace. The storage 20 is configured by an HDD (Hard Disk Drive) or an SSD (Solid State Drive), and stores various programs including the operating system, and various data. In the present embodiment, plural addresses that express locations on the network are stored in the ROM 16. Further, a communication starting program, which is for starting communication with the another ECU 100, and the like are stored in the ROM 16 or the storage 20. Note that, in the present embodiment, as an example, plural IP addresses are stored in the ROM 16, but the present disclosure is not limited to this, and other addresses such as MAC addresses or the like may be used.

The communication interface 22 is an interface for the ECU 10 to communicate with the another ECU 100 by a computer network, and, for example, standards of Ethernet® or the like are used therefor. In the present embodiment, Ethernet® standards are used.

A sensor main body 26 that serves as instrument that the ECU 10 controls is connected to the input/output interface 24. As an example, the sensor main body 26 of the present embodiment is a laser radar (LIDAR: Laser Imaging Detection and Ranging) that is installed at the vehicle transverse direction central portion of the front portion of the vehicle and that detects peripheral information of the vehicle. Further, laser radars are similarly installed also at the both side portions of the vehicle, respectively. The communication cable that extends from the ECU 10 to the another ECU 100 is connected to a first port 108 of the another ECU 100 that corresponds to the sensor main body 26.

(Structure of the Another ECU 100)

The another ECU 100 of the present embodiment is a central control device that carries out control of plural sensors that are installed in the vehicle, and is electrically connected to plural control devices including the ECU 10. Concretely, the another ECU 100 has plural communication mechanisms for carrying out communication with the respective control devices, including the ECU 10, respectively. In the present embodiment, the another ECU 100 has first communication instrument 102, second communication instrument 104 and third communication instrument 106.

The first communication instrument 102 includes the first port 108 and a first filter 110. The second communication instrument 104 includes a second port 112 and a second filter 114. The third communication instrument 106 includes a second port 116 and a third filter 118.

Here, instrument that are the destinations of connection are set in advance at the first port 108, the second port 112 and the second port 116. At the first port 108, as described above, the sensor main body 26 is set as the instrument that is the connection destination. Further, at the second port 112, as an example, an unillustrated laser radar that is at the right side of the vehicle is set as the instrument that is the connection destination. At the second port 116, an unillustrated laser radar that is at the left side of the vehicle is set as the instrument that is the connection destination.

In a case in which data is transmitted to the first port 108 from an address other than a specified address, the first filter 110 refuses receipt of this data. Similarly, in a case in which data is transmitted to the second port 112 from an address other than a specified address, the second filter 114 refuses receipt of the data. In a case in which data is transmitted to the second port 116 from an address other than a specified address, the third filter 118 refuses receipt of the data. Further, the first filter 110, the second filter 114 and the third filter 118 respectively are set so as to filter different addresses. Namely, the first filter 110 carries out filtering such that data from an address corresponding to the sensor main body 26 is received. Further, the second filter 114 caries out filtering such that data from an address corresponding to the laser radar at the vehicle right side is received. The third filter 118 carries out filtering such that data from an address corresponding to the laser radar at the vehicle left side is received.

(Functional Configuration of Communication Device 12 for Vehicle)

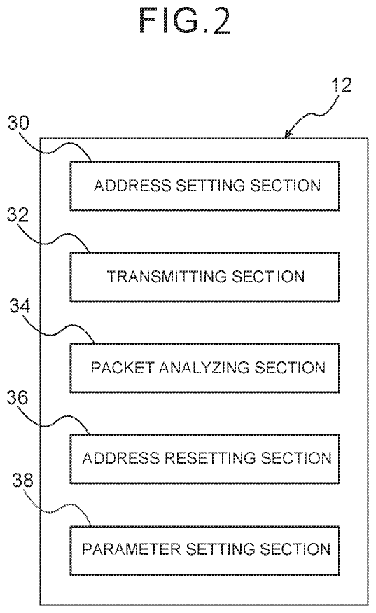

The communication device 12 for a vehicle that configures the ECU 10 realizes various functions by using the above-described hardware resources. The functional configurations that are realized by the communication device 12 for a vehicle are described with reference to FIG. 2.

As illustrated in FIG. 2, the communication device 12 for a vehicle is configured to include, as the functional structures thereof, an address set section 30, a transmit section 32, a packet analyzing section 34, an address reset section 36, and a parameter set section 38. These respective functional configurations are realized due to the CPU 14 reading-out a program that is stored in the ROM 16 or the storage 20, and executing the program by using the RAM 18 as a workspace.

The address set section 30 sets, as the address for communication between the ECU 10 and the another ECU 100, one address among plural addresses that are stored in the ROM 16. For example, the address set section 30 sets, as the address for communication, the first address of an address list that is stored in the ROM 16.

The transmit section 32 transmits data from the ECU 10 to the another ECU 100 by the address for communication that is set by the address set section 30. In the present embodiment, as an example, a ping message is transmitted. If a ping returns to the ECU 10, it is judged that the data was transmitted normally. On the other hand, if a ping does not return to the ECU 10, it is judged that the data was not transmitted.

The packet analyzing section 34 is a mechanism that analyzes the data (i.e., the packet) that is received from the another ECU 100.

If the data transmitted by the transmit section 32 cannot be received at the another ECU 100, the address reset section 36 newly sets, as the address for communication, another address from among the addresses in the ROM 16. Namely, if, after a ping message is transmitted from the transmit section 32, data is not returned to the ECU 10, it is judged that the data was not transmitted, and another address is set, as the address for communication, by the address reset section 36 from the list of the other addresses.

If the data that is transmitted by the transmit section 32 is received at the another ECU 100, the parameter set section 38, sets, on the basis of the address for communication, the parameter of the sensor main body 26 that the ECU 10 controls. Concretely, a table expressing relationships of correspondence between parameters of instrument and addresses for communication is stored in the ROM 16 or the storage 20. Then, by referring to the table, the parameter set section 38 acquires the parameter of the instrument that corresponds to the address for communication of the time when the data was transmitted, and sets this parameter as the parameter of the instrument. In the present embodiment, a parameter of a laser radar is set for the sensor main body 26. Note that what is called parameter here is a parameter such as the viewing angle of the sensor, or the like.

(Operation)

Operation of the present embodiment is described next.

(Example of Communication Starting Processing)

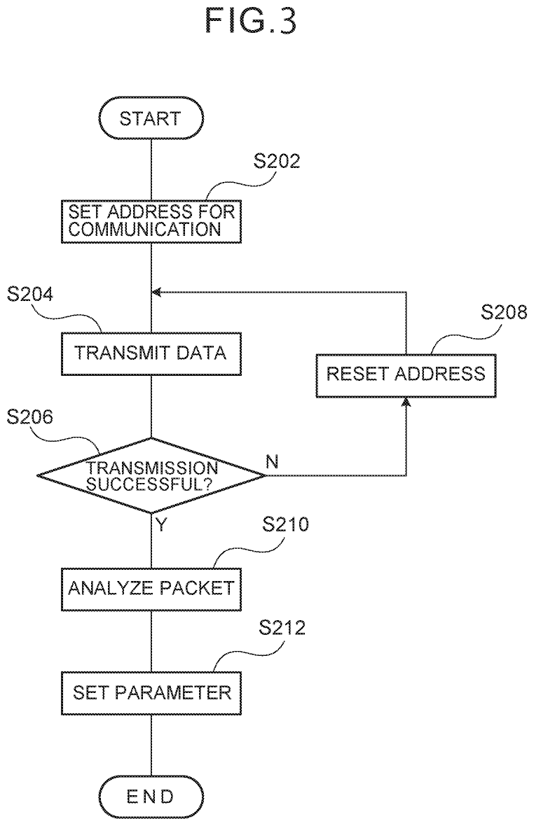

FIG. 3 is a flowchart illustrating an example of the flow of communication starting processing by the communication device 12 for a vehicle. Here, as an example, description is given of the communication starting processing at the time when electric power is supplied to the ECU 10 and the another ECU 100 in the state in which assembly of the vehicle has been completed.

In step S202, the CPU 14 sets the address for communication by the function of the address set section 30. Here, as described above, the first address in the address list that is stored in the ROM 16 is set as the address for communication (address setting step).

In step S204, by the function of the transmit section 32, the CPU 14 transmits data (a ping message) from the ECU 10 to the another ECU 100 (transmitting step).

Next, in step S206, the CPU 14 judges whether or not transmission was successful. Concretely, if a ping message returns, the CPU 14 judges that transmission was successful. If a predetermined time period elapses in a state in which a ping message has not returned, the CPU 14 judges that transmission was not successful. Here, a case in which a ping message returns is a case in which the data could be transmitted to the first port 108 of the another ECU 100 to which the ECU 10 is connected. Namely, this is a case in which receipt is not refused by the first filter 110.

If the CPU 14 judges in step S206 that transmission was successful, the CPU 14 moves on to the processing of step S210. Further, if the CPU 14 judges in step S206 that transmission was not successful, the CPU 14 moves on to the processing of step S208.

In step S208, by the function of the address reset section 36, the CPU 14 newly sets, as the address for communication, another address in the address list that is stored in the ROM 16 (address resetting step). In the present embodiment, the second address in the address list is newly set as the address for communication. Namely, the address, which is next after the address that had been set as the address for communication, is newly set as the address for communication, and the CPU 14 moves on to the processing of step S204. Therefore, resetting of the address is carried out by the address reset section 36 until transmission succeeds in step S206, and the transmission of data is carried out at the address that has been newly set.

On the other hand, in a case in which it is judged in step S206 that transmission was successful, the CPU 14 moves on to the processing of step S210, and analyzes the received packet by the function of the packet analyzing section 34.

Next, in step S212, by the function of the parameter set section 38, the CPU 14 sets the parameter of the sensor main body 26. In the present embodiment, a parameter, such as the detection viewing angle of the laser radar that is at the vehicle transverse direction central portion of the front portion of the vehicle, or the like, is set as the parameter of the sensor main body 26. Then, the CPU 14 ends the communication starting processing. Due thereto, the sensor main body 26 can be made to function as the laser radar at the vehicle transverse direction central portion of the front portion of the vehicle.

As described above, in the present embodiment, in a case in which data transmitted by the transmit section 32 cannot be received at the another ECU 100, another address is newly set by the address reset section 36 as the address for communication. Due thereto, even in a case in which devices having the same part number are installed on an in-vehicle network and addresses are duplicated, communication within the vehicle can be carried out correctly by due to the another address being newly set.

Further, in the present embodiment, because the sensor main body 26 that the ECU 10 controls is specified on the basis of the address for communication, the correct parameter of the sensor main body 26 can be set by the parameter set section 38. Due thereto, the sensor main body 26 can be controlled correctly by the ECU 10. In particular, in the present embodiment, a parameter, such as the detection viewing angle of a laser radar that is the sensor main body 26, or the like can be set correctly.

Moreover, in the present embodiment, because a filter is set per port, it is possible to be able to easily receive only the data from a specific address. Namely, merely by providing the first filter 110, the second filter 114 and the third filter 118, correct addresses, which correspond to the instrument controlled by the control devices that are connected thereto respectively, can be set reliably.

An embodiment and a modified example have been described above, but the present disclosure can, of course, be embodied in various forms within a scope that does not depart from the gist thereof. For example, in the above-described embodiment and modified example, the addresses are stored in the ROM 16, but the present disclosure is not limited to this, and plural addresses may be stored in another storage section.

Further, the above-described embodiment and modified example describe a laser radar, which is installed at the vehicle transverse direction central portion of the front portion of the vehicle, as an example of the sensor main body. However, the present disclosure is not limited to this. For example, the present disclosure may be applied to a control device that controls another sensor that is provided at an outer peripheral portion of the vehicle. Namely, the present disclosure may be applied to a communication device that configures a portion of a control device that controls a sensor such as an ultrasonic wave sensor, an optical camera, a millimeter wave radar, or the like. Further, the present disclosure is not limited to sensors, and may be applied to control devices that control other instrument such as lights or the like.

Moreover, in the above-described embodiment and modified example, Ethernet® is used as the standards of communication by the computer network. However, the present disclosure is not limited to the same. Namely, the present disclosure may be applied to an in-vehicle network that is constructed in accordance with another communication standard, provided that it is a communication standard in which addresses, which express location on the network at the time of communication between control devices, can be duplicate.

Still further, any of various types of processors other than a CPU may execute the communication starting processing that the CPU 14 executes by reading-in software (a program) in the above-described embodiment and modified example. Examples of processors in this case include PLDs (Programmable Logic Devices) whose circuit configuration can be changed after production such as FPGAs (Field-Programmable Gate Arrays) and the like, or dedicated electrical circuits that are processors having circuit configuration that are designed for the sole purpose of executing specific processings such as ASICs (Application Specific Integrated Circuits) and the like, or the like. Further, the communication starting processing may be executed by one of these various types of processors, or may be executed by combining two or more of the same type or different types of processors (e.g., plural FPGAs, or a combination of a CPU and an FPGA, or the like). The hardware configuration of these various types of processors are, more concretely, electrical circuits that combine circuit elements such as semiconductor elements and the like.

What is claimed is:

1. A communication device for a vehicle, comprising:
a memory; and
a processor coupled to the memory, the processor being configured to:
set one address, from a storage section in which a plurality of addresses are stored, as an address for communication for a time at which a first control device, which carries out control of a vehicle, communicates with a second control device,
transmit data from the first control device to the second control device via the address for communication, and
in a case in which the transmitted data cannot be received at the second control device, newly set another address from the storage section as the address for communication.

2. The communication device for a vehicle of claim 1, wherein, in a case in which the data transmitted from the first control device to the second control device is received at the second control device, the processor sets, on the basis of the address for communication, a parameter for an instrument that the first control device controls.

3. The communication device for a vehicle of claim 2, wherein the processor refers to a table, which is stored in the storage section and expresses correspondence relationships between parameters of instruments and addresses for communication, and sets a parameter for an instrument, which corresponds to the address for communication for the time at which the data was transmitted, as the parameter for the instrument that the first control device controls.

4. The communication device for a vehicle of claim 2, wherein the instrument is a sensor that detects peripheral information of the vehicle.

5. A communication system for a vehicle, comprising:
the communication device for a vehicle of claim 1; and
the second control device,
wherein a plurality of ports, which are for receiving data transmitted from an exterior, and filters, which are installed in each of the ports and refuse receipt of data transmitted from an address other than a specific address, are provided at the second control device.

6. A communication method comprising:
setting, by a processor, one address, from a storage section in which a plurality of addresses are stored, as an address for communication for a time at which a first control device, which carries out control of a vehicle, communicates with a second control device;
transmitting, by a processor, data from the first control device to the second control device via the address for communication; and
setting, by a processor, another address from the storage section as the address for communication in a case in which the transmitted data cannot be received at the second control device.
